(19) United States
(12) Patent Application Publication
(10) Pub. No.: US 2016/0063494 A1
(43) Pub. Date: Mar. 3, 2016

(54) BEFORE-THE-FACT BUDGETING

(71) Applicant: Srikanth Madduri, San Diego, CA (US)

(72) Inventor: Srikanth Madduri, San Diego, CA (US)

(73) Assignee: INTUIT INC., Mountain View, CA (US)

(21) Appl. No.: 14/470,777

(22) Filed: Aug. 27, 2014

(51) Int. Cl. G06Q 20/40; G06Q 20/38; G06Q 20/20

(52) U.S. Cl. CPC G06Q 20/405; G06Q 20/20; G06Q 20/3821

(57) ABSTRACT

A method, system, and computer readable medium to improve spending budget control based on purchase characteristic dependent payment rules. In one or more embodiments, the payment rules are implemented by a payment service that uses payment credentials specified in the payment rules to complete a purchase transaction while meeting the spending budget specified by the consumer.

### BACKGROUND

Financial transactions between a merchant and a consumer typically include the providing of goods and/or services by the merchant in exchange for payment from the consumer. The consumer may use a financial management application (FMA), such as Quicken® and/or Mint® (Quicken and Mint are trademarks of Intuit Inc., Mountain View, Calif.) to track the financial transactions, and, subsequently, the consumer's spending habits. In order to assist the consumer, the FMA may categorize financial transactions into categories. Thus, for example, a consumer may be able to determine the amount that the consumer spends on travel as compared to the amount that the consumer spends on utilities. Although the consumers often rely on the FMA to manage spending, the consumers cannot control their spending before it gets out of control because available FMAs only provide after-the-fact reports after the expense has been already been made, instead of providing any before-the-fact budgeting capability.

### SUMMARY

In general, in one aspect, the invention relates to a method for processing payments. The method includes obtaining, by an initial payment service, a plurality of payment rules, wherein the plurality of payment rules are based on a budget requirement of a consumer, obtaining, from the consumer by a point-of-sale (POS) unit of a merchant, an initial payment credential to pay for a first purchase, wherein the initial payment credential is used by the POS unit to identify the initial payment service, receiving, from the POS unit by a computer processor of the initial payment service, the initial payment credential and information of the first purchase to process a first payment for the first purchase, selecting, by the computer processor based on the initial payment credential and the information of the first purchase, a first payment rule from the plurality of payment rules, wherein the first payment rule specifies a first budget control condition to qualify the first purchase, retrieving, by the computer processor based on the initial payment credential and from a financial management application (FMA), first cumulative spending information of the consumer to qualify the first purchase based on the first budget control condition, and processing, subsequent to the retrieving from the FMA, the first payment in response to qualifying the first purchase.

In general, in one aspect, the invention relates to a system for processing payments. The system includes a point-of-sale (POS) unit of a merchant that is configured to obtain an initial payment credential of a consumer to pay for a first purchase, wherein the initial payment credential is used to identify an initial payment service to process a first payment for the first purchase, and the initial payment service interfacing with the POS unit and configured to obtain a plurality of payment rules, wherein the plurality of payment rules are based on a budget requirement of a consumer, receive, from the POS unit, the initial payment credential and information of the first purchase to process a first payment for the first purchase, select, based on the initial payment credential and the information of the first purchase, a first payment rule from the plurality of payment rules, wherein the first payment rule specifies a first budget control condition to qualify the first purchase, retrieve, based on the initial payment credential and from a financial management application (FMA), first cumulative spending information of the consumer to qualify the first purchase based on the first budget control condition, and process, subsequent to the retrieving from the FMA, the first payment in response to qualifying the first purchase.

In general, in one aspect, the invention relates to a non-transitory computer readable medium storing instructions for processing payments. The instructions, when executed by a computer processor, comprising functionality for obtaining, by an initial payment service, a plurality of payment rules, wherein the plurality of payment rules are based on a budget requirement of a consumer, obtaining, from the consumer by a point-of-sale (POS) unit of a merchant, an initial payment credential to pay for a first purchase, wherein the initial payment credential is used by the POS unit to identify the initial payment service, receiving, from the POS unit by the initial payment service, the initial payment credential and information of the first purchase to process a first payment for the first purchase, selecting, by the initial payment service based on the initial payment credential and the information of the first purchase, a first payment rule from the plurality of payment rules, wherein the first payment rule specifies a first budget control condition to qualify the first purchase, retrieving, by the initial payment service based on the initial payment credential and from a financial management application (FMA), first cumulative spending information of the consumer to qualify the first purchase based on the first budget control condition, and processing, subsequent to the retrieving from the FMA, the first payment in response to qualifying the first purchase.

Other aspects of the invention will be apparent from the following transaction description and the appended claims.

### BRIEF DESCRIPTION OF DRAWINGS

FIG. 1 shows a block diagram of a system in accordance with one or more embodiments of the invention.

FIG. 2 shows a flowchart in accordance with one or more embodiments of the invention.

FIGS. 3.1, 3.2, and 3.3 show an example in accordance with one or more embodiments of the invention.

FIG. 4 shows a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency. Further, in the figures, three collinear dots mean that more elements of the same type as before the three collinear dots may optionally exist in accordance with one or more embodiments of the invention.

In the following detailed transaction description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the transaction description.

In general, embodiments of the invention provide a method, system, and computer readable medium to improve spending budget control based on purchase characteristic dependent payment rules. In one or more embodiments, the payment rules are implemented by a payment service that uses payment credentials specified in the payment rules to complete a purchase transaction.

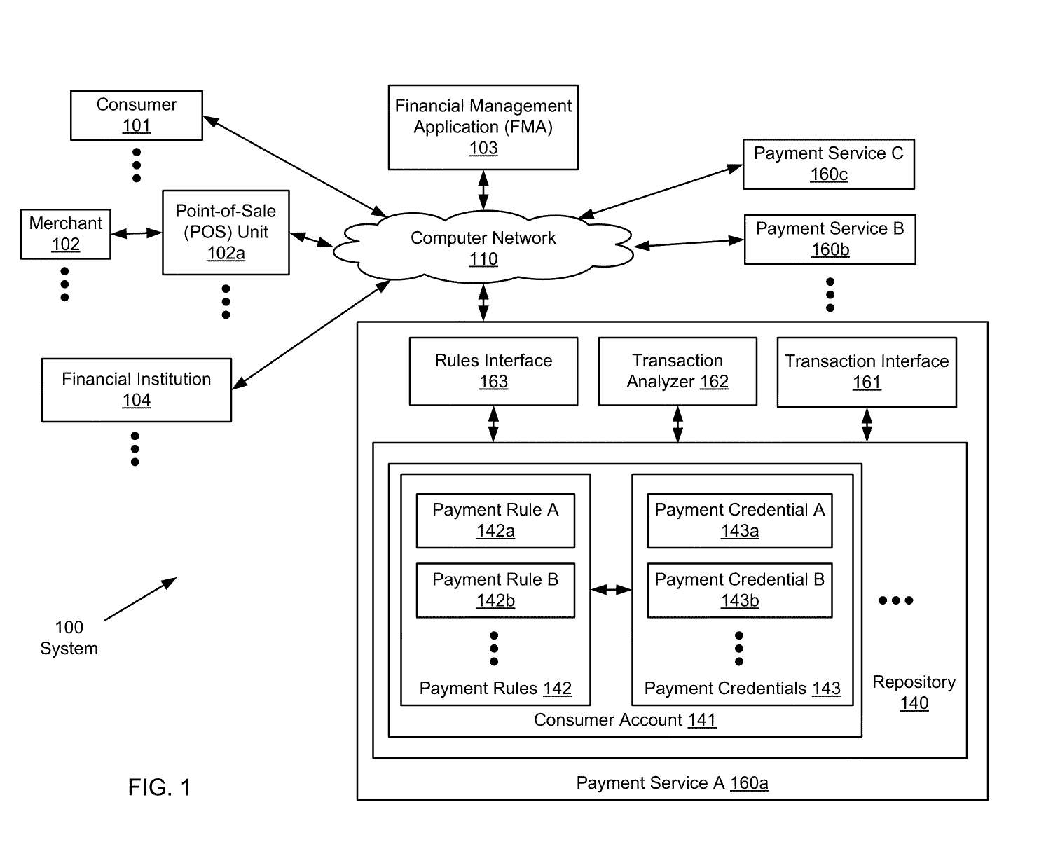

FIG. 1 shows a block diagram of a system (100) in accordance with one or more embodiments of the invention. Specifically, the system (100) includes a consumer (101), a point-of-sale (POS) unit (102a) operated by a merchant (102), a financial management application (FMA) (103) and a financial institution (104) that are used by the consumer (101), and payment services (e.g., payment service A (160a), payment service B (160b), payment service C (160c)) that process payments received from the consumer (101) to various merchants (e.g., merchant (102)). As shown in FIG. 1, these components of the system (100) are coupled via a computer network (110). Further, the payment service A (160a) includes a transaction interface (161), a transaction analyzer (162), a rules interface (163), and a repository (140) storing data used and/or generated by these elements of the payment service A (160a). In one or more embodiments of the invention, one or more of the modules and elements shown in FIG. 1 may be omitted, repeated, and/or substituted. Accordingly, embodiments of the invention should not be considered limited to the specific arrangements of modules shown in FIG. 1.

In one or more embodiments of the invention, a consumer (e.g., consumer (101)) is an individual consumer or business consumer. In particular, an individual consumer is a person or group (e.g., family or other organization) that consumes goods and/or services. A business consumer is a business that consumes goods and/or services. In one or more embodiments, the consumer (101) may include any computing device configured with computing, data storage, and network communication functionalities. Further, as used herein, the consumer (101) is deemed to perform an action when the action is performed on behalf of the consumer (101). For example, an owner, agent, or officer may act on behalf of the consumer (101) to perform an action.

In one or more embodiments of the invention, a merchant (e.g., merchant (102)) is an organization engaged in the trade of goods, services, or both to consumers. For example, the merchant may be a sole proprietorship, partnership, company, non-profit organization, etc. and may also be referred to as vendor. In one or more embodiments of the invention, the merchant has a storefront located in at least one physical location. Alternatively or additionally, the merchant may correspond to an Internet merchant that has an associated website. In one or more embodiments of the invention, the goods and/or services sold by the merchant correspond to the products sold by the merchant to the consumers.

In one or more embodiments of the invention, a merchant includes functionality to perform one or more financial transactions with one or more consumers. A financial transaction is the exchange of a product for payment. A financial transaction may be a sale of a product, a return of a product, a down payment on a product, or any other exchange of products that involve finances.

In one or more embodiments of the invention, a point-of-sale (POS) unit (e.g., POS unit (102a)) corresponds to hardware and/or software used for the sale of goods. In particular, the POS unit (102a) may include functionality to process purchases, obtain product codes for the identification of items, and perform other functions related to the sale of goods. In one or more embodiments, the POS unit (102a) is configured to obtain payment credentials of consumers (e.g., consumer (101)) to pay for purchases from the merchant (102). In addition, the POS unit (102a) is configured to submit the payment credentials to a POS payment processor designated by the merchant (102) to process payments. Based on the payment credentials, corresponding payment services (e.g., payment service A (160a), payment service B (160b), payment service C (160c)) are identified to process payments for the purchases. For example, the POS unit (102a) may be used in a physical store of the merchant (102) and include a card reader (e.g., credit/debit card reader), a bar code reader, a receipt printer, an inventory scanner (e.g., RFID, Bar Code, Quick Response (QR) codes/matrix barcodes, etc.), a pin pad, computer system(s), and other devices. In the physical store example, the POS unit (102a) includes a physical device that may be provided by the POS payment processor designated by the merchant (102). In another example, the POS unit (102a) may be used for an online store of the merchant (102) and correspond to software modules having functionality to perform the tasks required for sale of goods.

In one or more embodiments of the invention, the computer network (110) may include a cellular phone network, a wide area network, a local area network, a public switched telephone network (PSTN), a financial network, any other suitable network that facilitates the exchange of information from one part of the network to another, or a combination thereof. In one or more embodiments, the computer network (110) is coupled to or overlaps with the Internet.

In one or more embodiments of the invention, the FMA (103) is a set of software solutions designed to manage financial transactions and other financial needs of the consumer (101). In one or more embodiments of the invention, the FMA (103) may be a personal financial software, a tax preparation application, or any other financial management application suitable for an individual consumer or a business consumer. In one or more embodiments, the FMA (103) is provided by an application service provider, such as a software as a service (SaaS). For example, the FMA (103) may be operated by the application service provider (ASP) and accessed by the consumer (101) on a subscription basis. In one or more embodiments, the FMA (103) is configured to retrieve the transaction records from financial institutions (e.g., bank, credit card service provider, etc., such as the financial institution (104)) used by the consumer (101). Further, the FMA (103) stores and analyzes the retrieved transaction records to generate reports for the consumer (101).

In one or more embodiments of the invention, the FMA (103) is configured to generate payment rules based on a budget requirement of the consumer (101), and analyze the retrieved transaction records based on the budget requirement to generate a result to be included in the reports. In one or more embodiments, a payment rule is a rule that specifies a budget control condition for processing payments based on a type or other attribute of purchases. For example, the attribute may include a type of the merchandise, a type of the merchant, time and/or date of the purchase, a price range of the purchase, etc. In one or more embodiments, the purchase is characterized based on the type or attribute and is assigned a category of the purchase. In one or more embodiments, the payment rules are provided to the payment service A (160a) as the payment rules (142), for implementation to meet the budget requirement of the consumer (101). For example, the payment rules (142) includes the payment rule A (142a) to specify a payment credential (e.g., payment credential A (143a), payment credential B (143b)) of the consumer (101) to be used for a particular type of purchase. In another example, the payment rules (142) includes the payment rule B (142b) to specify a spending limit for a particular type of purchase over a pre-determined time period (e.g., weekly spending limit, monthly spending limit, etc.).

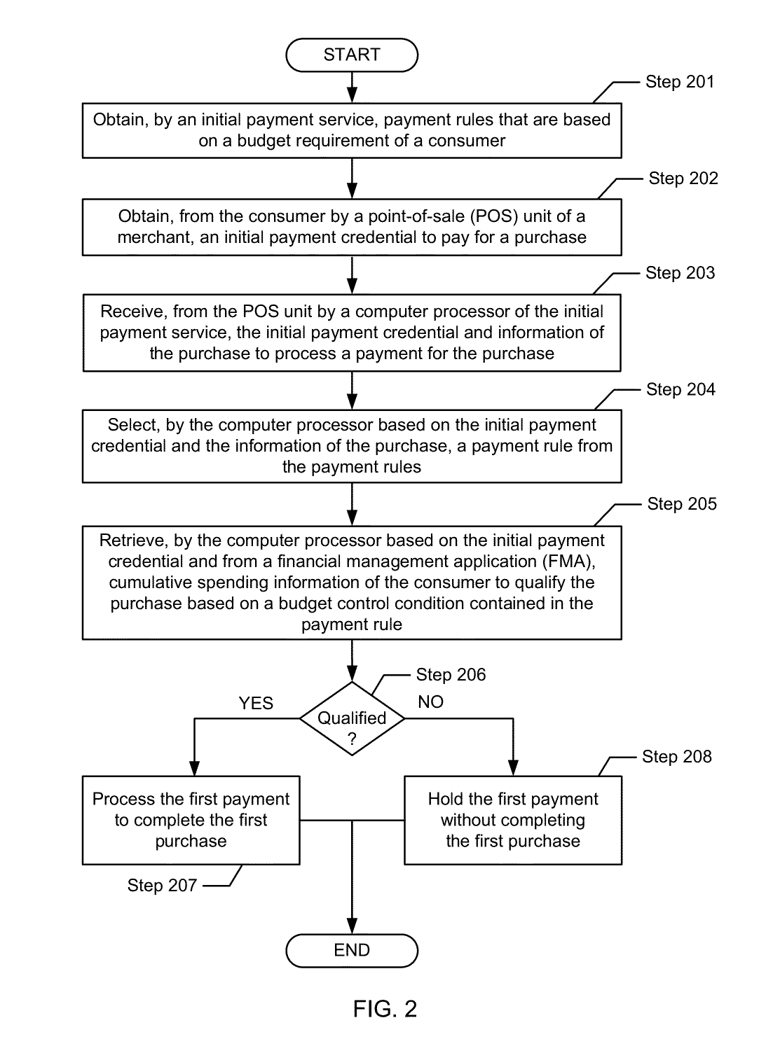

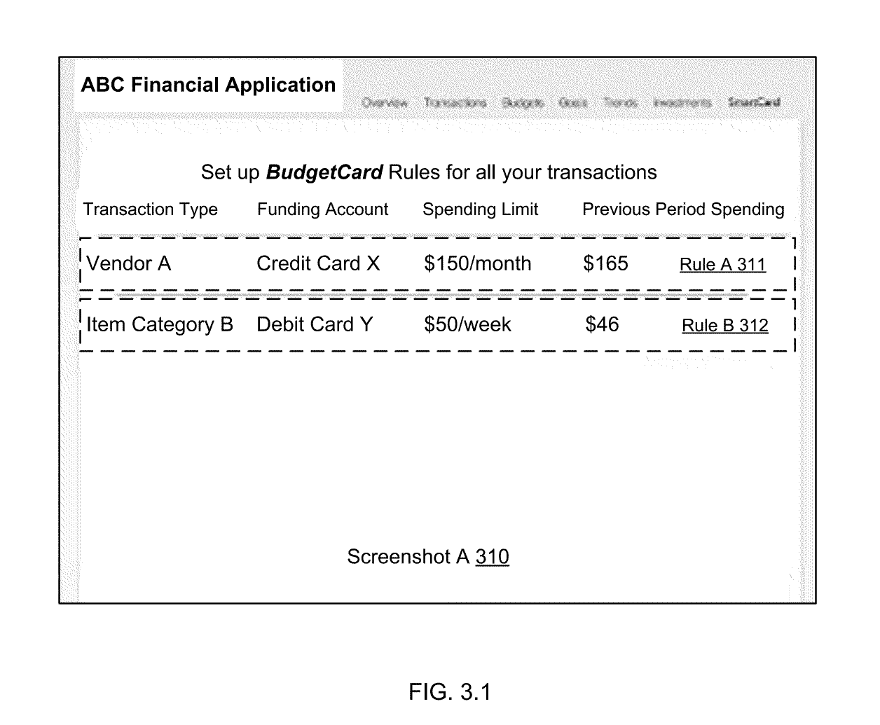

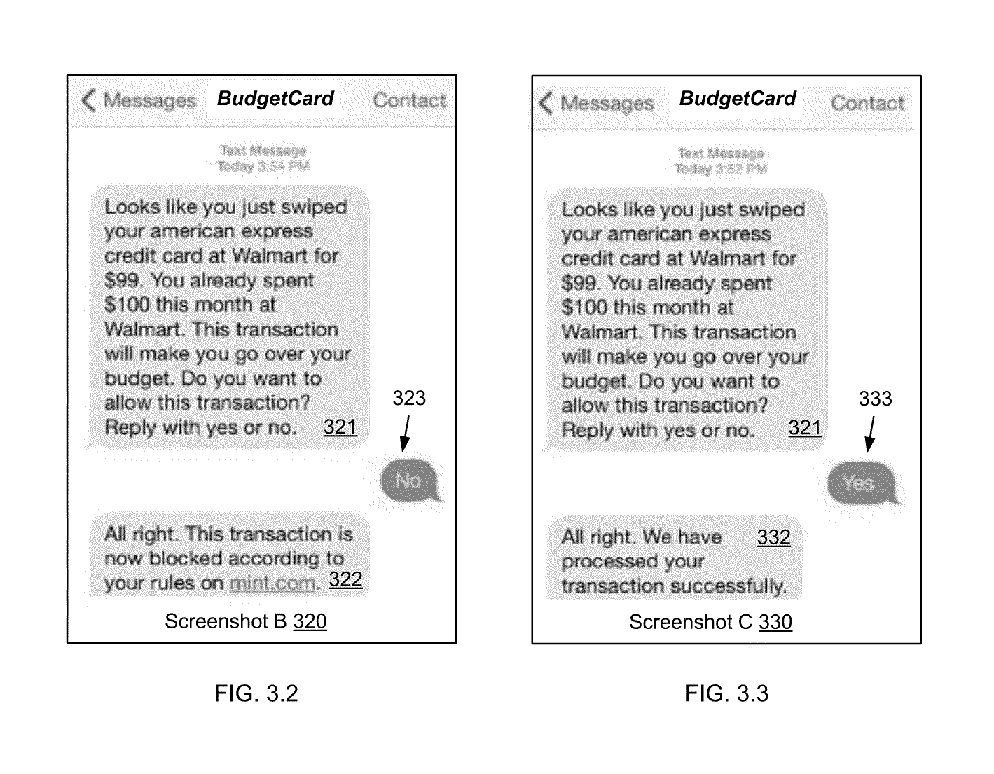

In one or more embodiments of the invention, the payment rules (142) are specific to the consumer (101) and are stored in the consumer account (141) maintained by the payment service A (160a) for the consumer (101). In one or more embodiments, a collection of payment credentials (i.e., payment credentials (143), including e.g., payment credential A (143a), payment credential B (143b), etc.) of the consumer (101) is also stored in the consumer account (141). For example, the payment credentials (143) are specified by the payment rules (142) and may be stored with the payment rules (142) in a pre-determined data structure. In one or more embodiments, the FMA (103) and payment service A (160a) use the method described in reference to FIG. 2 to collectively generate and implement the payment rules (142) based on the payment credentials (143) of the consumer (101). Examples of generating and implementing the payment rules (142) are described in reference to FIGS. 3.1-3.x below.

A payment service provider is an entity performing a particular task in processing payment transactions for a merchant (e.g., merchant (102)). A payment network includes a chain of payment service providers, each providing unique value in processing payment transactions for the merchant (e.g., merchant (102)). For example, processing a credit card payment may involve the merchant (102), a POS payment processor designated by the merchant (102), an aggregator, a credit card processor, and the merchant's bank. The POS payment processor, the aggregator, the credit card processor, and the merchant's bank are examples of payment service providers. The POS payment processor is usually a smaller company that provides customer support to the merchant (102) and is the receiver of the POS transactions of the merchant (102). The POS payment processor represents the aggregator to the merchant (102). The POS payment processor's transaction volumes are small compared to the aggregator's transaction volumes. The POS payment processor does not handle enough transaction volumes to warrant a direct connection to the major credit card networks. The merchant (102) also does not handle enough transaction volumes to warrant a direct connection to the aggregator. In this way, scope and responsibilities are divided among the various payment service providers. In one or more embodiments, the payment service provider may include any computing device configured with computing, data storage, and network communication functionalities. The payment service provider and associated computing device are collectively referred to as a payment service, such as the payment service A (160a), payment service B (160b), payment service C (160c), etc.

In one or more embodiments of the invention, the payment service A (160a) includes the repository (140) that may in turn include a disk drive storage device, a semiconductor storage device, a database management system, other suitable computer data storage device, or combinations thereof. In one or more embodiments, content stored in the repository (140) may be a data file, a linked list, a data sequence, a database, a graphical representation, or any other suitable data structure. In one or more embodiments of the invention, the repository (140) includes functionality to store data for the transaction interface (161), the transaction analyzer (162), and the rules interface (163). Each of these components is described below.

In one or more embodiments of the invention, the consumer (101) obtains a payment credential (referred to as the initial payment credential) issued by the payment service A (160a) for making payments with budget control capability. Accordingly, when the consumer (101) submits the initial payment credential to the POS unit (102a) to process a payment for a purchase, the payment service A (160a) is identified to receive information of the purchase (e.g., merchandise description and quantity, price and other amount, date and time, etc.) for processing the payment with budget control. In one or more embodiments, the payment service A (160a) is identified by the POS unit (102a) based on the initial payment credential. In one or more embodiments, the POS unit (102a) submits the initial payment credential to a payment processor (e.g., payment service C (160c)) designated by the merchant (102) for processing payments for the merchant (102). In such embodiments, the payment service A (160a) is identified by the merchant designated payment processor based on the initial payment credential.

In one or more embodiments of the invention, the payment service A (160a) includes the rules interface (163) that corresponds to hardware and/or software that is configured to obtain the payment rules (142) for processing payments for the consumer (101). In one or more embodiments, the payment rules (142) are obtained directly from the consumer (101) via the rules interface (163). In one or more embodiments, the payment rules (142) are generated by the FMA (103) and obtained from the FMA (103) via the rules interface (163).

In one or more embodiments of the invention, the payment service A (160a) includes the transaction interface (161) that corresponds to hardware and/or software that is configured to receive the initial payment credential and information of the purchase to process the payment. In one or more embodiments, the information of the purchase is received directly from the POS unit (102a). In one or more embodiments where the POS unit (102a) submits the initial payment credential to a payment processor (e.g., payment service C (160c)) designated by the merchant (102), the information of the purchase is received from the merchant designated payment processor.

In one or more embodiments of the invention, the payment service A (160a) includes the transaction analyzer (162) that corresponds to hardware and/or software that is configured to select, based on the information of the purchase, a payment rule (e.g., payment rule (142a)) from the consumer account (141), in particular, from the payment rules (142). In particular, the payment rule (142a) specifies the payment credential (143a) to be used for processing the payment. In one or more embodiments, the transaction analyzer (162) analyzes the information of the purchase (e.g., merchandise description and quantity, price and other amount, date and time, etc.) to determine a type of the purchase, and in turn select the payment rule (e.g., payment rule (142a)) based on the type of the purchase.

In one or more embodiments, the payment service A (160a) includes functionality to process payment directly using the payment credential (143a). In one or more embodiments, the payment service A (160a) sends the payment credential (143a) and the information of the purchase to a partnering payment processor (e.g., payment service B (160b)) for processing the payment. “Processing the payment”, as used herein, refers to debiting an amount of the payment from a financial account associated with the payment credential (143a) and crediting a merchant account of the merchant (102). In one or more embodiments, the debiting and crediting are performed via a national payment network, such as the ACH network. Whether processed directly by the payment service A (160a), or in directly through the payment service B (160b), a confirmation of the payment is sent to the POS unit (102a) to complete the purchase. For example, the confirmation may be sent by the payment service A (160a) or by the payment service B (160b) to the POS unit (102a). In one or more embodiments, the POS unit (102a) generates a receipt for the consumer (101), identifying the payment being performed using the initial payment credential, where the payment credential A (143a) is hidden from the receipt. In one or more embodiments, the receipt may include the payment credential A (143a).

In one or more embodiments of the invention, the payment service A (160a) uses the method described in reference to FIG. 2 for processing the payment with budget control. An example of the payment service A (160a) processing payments with budget control is described in reference to FIGS. 3.1-3.x below.

Although only one consumer, one merchant, one POS unit, and one consumer account are described in detail above, multiple consumers, multiple merchants, multiple POS units, and/or multiple consumer accounts may exist in embodiments of the invention.

FIG. 2 shows a flowchart in accordance with one or more embodiments of the invention. In one or more embodiments of the invention, the method of FIG. 2 may be practiced using the system (100) described in reference to FIG. 1 above. In one or more embodiments of the invention, one or more of the steps shown in FIG. 2 may be omitted, repeated, and/or performed in a different order than that shown in FIG. 2. Accordingly, the specific arrangement of steps shown in FIG. 2 should not be construed as limiting the scope of the invention.

Initially, in Step 201, a set of payment rules are obtained. In one or more embodiments, the set of payment rules are based on a budget requirement of a consumer. For example, the budget requirement may include a monthly cafe spending budget, such as a maximum spending limit and/or particular payment method for cafe spending. In one or more embodiments, the budget requirement is specified by the consumer using a user interface of a financial management application (FMA) used by the consumer. Accordingly, the set of payment rules are generated by the FMA based on the budget requirement. In one or more embodiments, the set of payment rules are obtained by a payment service (referred to as the initial payment service) that provides automatic budget control function to the consumer.

In Step 202, a payment credential is obtained from the consumer, by a point-of-sale (POS) unit of a merchant, to pay for a purchase. In one or more embodiment, the payment credential is issued by the initial payment service and referred to as the initial payment credential. Specifically, the initial payment credential is for the consumer to make purchases with automatic budget control. In one or more embodiment, the POS unit is a physical device installed in a physical store of the merchant, where the initial payment credential is associated with a physical payment card for the consumer to make purchases. In one or more embodiment, the POS unit is a user interface of an online store of the merchant, where the initial payment credential is a number or code that is input into the POS unit by the consumer via the user interface. In one or more embodiment, the POS unit uses the payment credential to identify the initial payment service. Specifically, the POS unit submits the initial payment credential and information of the purchase to the initial payment service for processing.

In Step 203, the initial payment credential and information of the first purchase are received from the POS unit by a computer processor of the initial payment service to process a payment for the purchase with automatic budget control.

In Step 204, based on the initial payment credential and the information of the purchase, a payment rule is selected by the initial payment service from the set of payment rules. In particular, the payment rule specifies a budget control condition to qualify the purchase. In one or more embodiments, the budget control condition includes a maximum spending amount for a particular category of purchase during a pre-determined time window. For example, a maximum cafe spending limit for monthly cafe purchases may be specified (e.g., as $100) in the budget control condition. In one or more embodiments, the budget control condition includes one or more payment credential designated for a particular category of purchase. For example, the budget control condition may include a VISA® card information and a MasterCard® information to split auto fueling expenses.

In Step 205, based on the initial payment credential and from the FMA, the initial payment service retrieves cumulative spending information of the consumer to qualify the purchase based on the budget control condition contained in the selected payment rule.

In Step 206, it is determined whether the purchase is qualified under the automatic budget control. In one or more embodiments, the cumulative spending information is used to quality the purchase based on the budget control condition. For example, the cumulative spending information represents a cumulative cafe spending amount during the current month and the purchase is a cafe purchase. Accordingly, the sum of the cumulative cafe spending amount and the cafe purchase amount is compared to the maximum cafe spending limit specified in the payment rule to determine whether the cafe purchase is qualified. In other words, the cafe purchase is qualified if the sum is less than the maximum cafe spending limit. Otherwise, the cafe purchase is disqualified if the sum equals or exceeds the maximum cafe spending limit.

In Step 206, if the determination is positive, i.e., the purchase is qualified, the method proceeds to Step 207. Otherwise if the determination is negative, i.e., the purchase is disqualified, the method proceeds to Step 208.

In Step 207, subsequent to retrieving the cumulative spending information from the FMA and qualifying the purchase, the payment is processed to complete the purchase. In one or more embodiments, the payment rule specifies to process the qualified purchase using an account balance associated with the initial payment credential and maintained by the initial payment service for the consumer. In such embodiments, the payment is processed by the initial payment service by deducting the purchase amount from the consumer's account balance.

In one or more embodiments, the payment rule specifies to process the qualified purchase using another payment credential associated with a corresponding payment service. In such embodiments, the initial payment service submits the specified payment credential and the information of the purchase to the corresponding payment service for processing. In one or more embodiments, the payment rule specifies to split the qualified purchase among multiple payment credentials for processing. In such embodiments, the initial payment service submits the specified payment credentials and the information of the purchase to the corresponding payment services for processing.

Whether the payment is processed by the initial payment service directly, or submitted to other payment service(s) for processing, an acknowledgement is returned to the POS unit indicating that the payment process is complete and the merchandise is authorized to be released to the consumer.

In Step 208, subsequent to retrieving the cumulative spending information from the FMA and disqualifying the purchase, the payment is held without completing the purchase. In one or more embodiments, a notification is sent to a mobile device of the consumer. Specifically, the notification informs the consumer of disqualifying the purchase based on the budget control condition resulting in holding the payment. Based on the consumer's discretion after viewing the notification, the consumer's authorization may be received from the mobile device to continue processing the payment by overriding the holding. In response to the authorization, the payment is then processed to complete the purchase.

Whether the payment is processed via the Step 207 or the Step 208, from time to time subsequent to the purchase, the FMA retrieves from a financial institution processing the payment, a financial transaction record representing the payment. For example, the financial institution may be the initial payment service or another payment service as described above. The financial transaction record may represent a cafe purchase made by the consumer. Accordingly, the FMA analyzes the spending of the consumer, based at least on the financial transaction record and the aforementioned cumulative spending information, to generate a result. For example, the result may be a total monthly cafe spending. In one or more embodiments, the FMA generates a report based on a comparison of the result and the budget requirement. For example, the report may compare the monthly cafe spending budget and the actual total monthly cafe spending.

FIGS. 3.1, 3.2, and 3.3 show an example in accordance with one or more embodiments of the invention. In one or more embodiments, the example shown in FIGS. 3.1, 3.2, and 3.3 is based on the system (100) depicted in FIG. 1 above and the method flowchart depicted in FIG. 2 above.

FIG. 3.1 shows a screenshot A (310) of ABC Financial Application, which is an example of the FMA (103) depicted in FIG. 1 above. Using the ABC Financial Application, a user “John” (not shown) may set up his payment rules based on a BudgetCard that is issued to him by a budget-control payment service. For example, the BudgetCard is a physical plastic card embossed with a BudgetCard number and an expiration date. The budget-control payment service is an example of the initial payment service, and the information on the BudgetCard is an example of the initial payment credential, as described in reference to FIG. 1 above. The screenshot A (310) shows a rule A (311) and a rule B (312) corresponding to the payment rule A (142a) and the payment rule B (142b), depicted in FIG. 1 above. The rule A (311) specifies that a credit card X (e.g., American Express® credit card) is to be used for any purchase from a vendor A (e.g., Walmart®) and that total purchase from the vendor A should not exceed $150 per month as John's goal. The rule B (312) specifies that a debit card Y (e.g., City Bank® debit card) is to be used for any purchase in an item category B (e.g., cafe category) and that total purchase in the item category B should not exceed $50 per week as John's goal.

The ABC Financial Application periodically downloads John's financial transaction records from multiple financial institutions used by John, including the financial institutions that issued the credit card X and the debit card Y. When John specifies the vendor A and the per month spending limit in the rule A (311), the ABC Financial Application compiles all financial transaction records associated with the vendor A in the previous month and displays the total amount of $165 under the previous period spending column. For example, if John sets up the payment rules on Aug. 19, 2014, the ABC Financial Application compiles all July financial transaction records associated with the vendor A. The total amount may be computed based on all payment methods used, or limited to the credit card X that is specified by John as the funding account. Upon viewing the previous period spending information (i.e., $165), John may adjust the spending limit (e.g., $150/month) accordingly. Similarly, when John specifies the item category B and the per week spending limit in the rule B (312), the ABC Financial Application compiles all financial transaction records in the item category B in the previous week and displays the total amount of $46 under the previous period spending column. Upon viewing the previous period spending information (i.e., $46), John may adjust the spending limit (e.g., $50/week) accordingly. In addition, similar to the previous period spending information, a cumulative spending amount that is tallied based on current period financial transaction records may also be displayed. For example, if John sets up the payment rules on Aug. 19, 2014, the ABC Financial Application compiles all August financial transaction records up to Aug. 18, 2014, associated with the vendor A. Accordingly, John may periodically check his up-to-date cumulative spending total amount of purchases made with vendor A, or in the item category B, as compared to the spending limits that he set up as the goals.

Although only two payment rules are shown in FIG. 3.1, additional payment rules may be set up by John, such as Rule #1 through Rule #8 below:
Rule #1. If a transaction amount is above $5000, block the transaction
Rule #2. All my grocery purchase are routed to my Visa® card account
Rule #3. All my gas purchases are routed through my American Express®
Rule #4. All my online purchases are routed to my American Express®
Rule #5. Amazon® purchases should go to Discover® Credit Card
Rule #6. My mortgage payments are routed through my Checking account
Rule #7. Block the transaction if I over-spend on groceries in any given month
Rule #8. If a transaction amount is between $3000 and $4000, split it between the Visa® and American Express® accounts equally

John uses the ABC Financial Application to manage his personal finances. From time to time, John downloads his financial transactions from banks and credit card companies into the ABC Financial Application so that he can review his spendings using a single application. For example, all financial transaction records associated with a particular vendor A (e.g., Walmart®) may be downloaded from multiple financial institutions for computing an up-to-date cumulative spending at the vendor A for John. John has used the ABC Financial Application as a user interface to access the budget-control payment service and generate the payment rules for an automatic budget control function. In particular, the payment rules allow John to maintain his spending toward a budget goal. Using the BudgetCard issued to John by the budget-control payment service, he can link all of his bank accounts, credit cards, debit cards, ATM cards, and electronic payment accounts to the BudgetCard account. Once the BudgetCard is linked to John's other payment accounts, John can use just the BudgetCard for all transactions online and at retail outlets. Any transaction paid by John using the BudgetCard will be submitted by the POS to the budget-control payment service, which is identified based on John's BudgetCard information. The budget-control payment service in turn uses John's BudgetCard information to look up and execute John's payment rules in order of priority (e.g., the highest priority on top as shown in FIG. 1).

The budget-control payment service uses priority specified by John for conflict management. For example, when John makes a purchase from the online store Amazon® for $5001.00, Rule #4 (i.e., using American Express® for online purchases) supersedes Rule #5 (i.e., using Discover® Credit Card for Amazon® purchases). In addition, the transaction amount is $5001.00 which violates #1, so the transaction is blocked and the John will receive a text message or an email (depending on John's preset preference) regarding the blocked transaction. In another example, John is making a grocery purchase at Target® Stores for $200.00. The purchase is paid by charging John's linked Visa® card according to Rule #2. In yet another example with respect to the rule A (311), when John tries to make a purchase at the vendor A (e.g., Walmart®) for $99 on Aug. 25, 2014, the budget-control payment service retrieves, from the ABC financial application, current month (i.e., August, 2014) financial transaction records associated with the vendor A (e.g., Walmart®) and computes the up-to-date cumulative spending at the vendor A to be $100. Because the $99 pending transaction would increase the cumulative spending at the vendor A to be $199, exceeding the spending limit $150 as specified in the rule A (311), the budget-control payment service temporarily blocks this $99 pending transaction. Once temporarily blocked, a notification is returned to the POS to inform a staff of the vendor A to hold the payment and the transaction. In addition, a separate notification is also sent to John's mobile device, on file at the budget-control payment service, to provide additional details of the temporarily blocked transaction.

FIG. 3.2 shows an example screenshot B (320) of John's mobile device. Specifically, the screenshot B (320) shows a chat session initiated from “BudgetCard” (representing the budget-control payment service) to John. The initial chat message (321) informs John that the $99 Walmart® pending purchase would make John go over his budget, and therefore is blocked. The initial chat message (321) provides an option for John to override the payment block and allow the transaction. In the example scenario where John replies with the chat message (323) disallowing this $99 Walmart® pending purchase, the budget-control payment service sustains the transaction block and sends the confirmation message (322) to John. In a different example scenario, depicted in FIG. 3.3 as the screenshot C (330), John replies with the chat message (333) allowing this $99 Walmart® pending purchase. In response, the budget-control payment service removes the temporary transaction block and sends the confirmation message (332) to John. In either example scenario, the resultant cumulative spending amount with or without this $99 purchase may be reflected in a report generated by the ABC financial application for John to compare to the spending limits that he set up as the goal. For example, as noted above, this report may be integrated with the screenshot A (310) shown in FIG. 3.1 above.

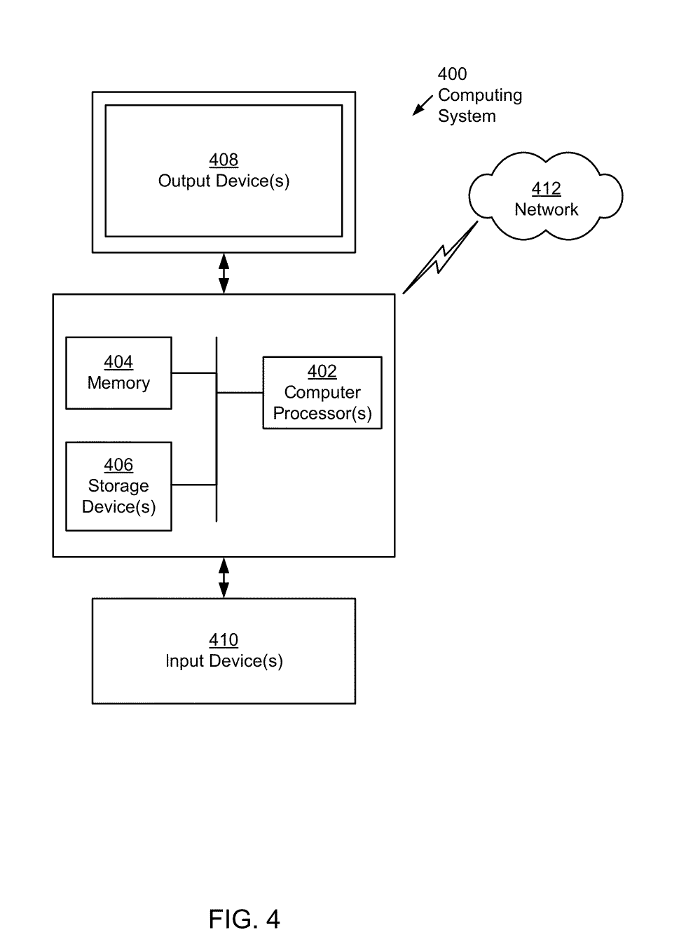

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device. The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and connected to the other elements over a network (412). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for processing payments, comprising:
obtaining, by an initial payment service, a plurality of payment rules, wherein the plurality of payment rules are based on a budget requirement of a consumer;
obtaining, from the consumer by a point-of-sale (POS) unit of a merchant, an initial payment credential to pay for a first purchase, wherein the initial payment credential is used by the POS unit to identify the initial payment service;
receiving, from the POS unit by a computer processor of the initial payment service, the initial payment credential and information of the first purchase to process a first payment for the first purchase;
selecting, by the computer processor based on the initial payment credential and the information of the first purchase, a first payment rule from the plurality of payment rules, wherein the first payment rule specifies a first budget control condition to qualify the first purchase;
retrieving, by the computer processor based on the initial payment credential and from a financial management application (FMA), first cumulative spending information of the consumer to qualify the first purchase based on the first budget control condition; and
processing, subsequent to the retrieving from the FMA, the first payment in response to qualifying the first purchase.

2. The method of claim 1,
wherein the POS unit comprises a physical device installed in a physical store of the merchant, and
wherein the initial payment credential is captured by the POS unit from a BudgetCard of the consumer.

3. The method of claim 1,
wherein the POS unit comprises a user interface of an online store of the merchant, and
wherein the initial payment credential is input into the POS unit by the consumer via the user interface.

4. The method of claim 1, further comprising:
generating, by the FMA, the plurality of payment rules based on the budget requirement;
retrieving, by the FMA and from a financial institution processing the first payment, a financial transaction record representing the first payment;
analyzing, by the FMA, spending of the consumer based at least on the financial transaction record and the first cumulative spending information to generate a result; and
generating, by the FMA, a report based on a comparison of the result and the budget requirement.

5. The method of claim 1, wherein the first payment rule further specifies a first payment credential of the consumer, and wherein processing the first payment comprises:
identifying, by the initial payment service, a first payment service based on the first payment credential; and
sending, by the initial payment service, the first payment credential to the first payment service to process the first payment.

6. The method of claim 5, wherein processing the first payment further comprises:
identifying, by the initial payment service, a second payment service based on a second payment credential of the consumer,
wherein the first payment rule further specifies the second payment credential and a ratio to split the first payment between using the first payment credential and using the second payment credential; and
sending, by the initial payment service, the second payment credential to the second payment service to process the first payment.

7. The method of claim 1, further comprising:
further obtaining, from the POS unit, the initial payment credential to pay for a second purchase from the merchant;
further identifying, by the POS unit and based on the initial payment credential, the initial payment service to process a second payment for the second purchase;
receiving, from the POS unit by the computer processor, the initial payment credential and information of the second purchase to process the second payment;
selecting, by the computer processor and based on the initial payment credential and the information of the second purchase, a second payment rule from the plurality of payment rules, wherein the second payment rule specifies a second budget control condition to quality the second purchase;
retrieving, by the computer processor based on the initial payment credential and from the FMA, second cumulative spending information of the consumer to disqualify the second purchase based on the second budget control condition; and
holding, by the computer processor in response to disqualifying the second purchase, the second payment without completing the second purchase.

8. The method of claim 7, further comprising:
sending, by the computer processor to a mobile device of the consumer, a notification of disqualifying the second purchase based on the second budget control condition resulting in holding the second payment;
receiving, from the mobile device and in response to the consumer viewing the notification, authorization to continue processing the second payment by overriding the holding; and
processing, in response to the authorization, the second payment to complete the second purchase.

9. A system for processing payments, comprising:
a point-of-sale (POS) unit of a merchant that is configured to:
obtain an initial payment credential of a consumer to pay for a first purchase,
wherein the initial payment credential is used to identify an initial payment service to process a first payment for the first purchase; and
the initial payment service interfacing with the POS unit and configured to:
obtain a plurality of payment rules, wherein the plurality of payment rules are based on a budget requirement of a consumer;
receive, from the POS unit, the initial payment credential and information of the first purchase to process a first payment for the first purchase;
select, based on the initial payment credential and the information of the first purchase, a first payment rule from the plurality of payment rules, wherein the first payment rule specifies a first budget control condition to qualify the first purchase;
retrieve, based on the initial payment credential and from a financial management application (FMA), first cumulative spending information of the consumer to qualify the first purchase based on the first budget control condition; and
process, subsequent to the retrieving from the FMA, the first payment in response to qualifying the first purchase.

10. The system of claim 9, further comprising:
a mobile device of the consumer that is configured to display a notification of processing the first payment using the first payment credential,
wherein the initial payment service is further configured to send the notification to the mobile device.

11. The system of claim 9, further comprising the FMA used by the consumer, wherein the FMA is configured to:
generate the plurality of payment rules based on a budget requirement specified by the consumer;
retrieve, from a financial institution processing the first payment, a financial transaction record representing the first payment;
analyze spending of the consumer based at least on the financial transaction record to generate a result; and
generate a report based on a comparison of the result and the budget requirement.

12. The system of claim 9, further comprising a first payment service, wherein processing the first payment comprises:
identifying, by the initial payment service, the first payment service based on the first payment credential; and
sending, by the initial payment service, the first payment credential to the first payment service to process the first payment.

13. The system of claim 12, further comprising a second payment service, wherein processing the first payment further comprises:
identifying, by the initial payment service, a second payment service based on a second payment credential of the consumer,
wherein the first payment rule further specifies the second payment credential and a ratio to split the first payment between using the first payment credential and using the second payment credential; and
sending, by the initial payment service, the second payment credential to the second payment service to process the first payment.

14. The system of claim 9, wherein the initial payment service is further configured to:
further obtain, from the POS unit, the initial payment credential to pay for a second purchase from the merchant, wherein the POS unit further identifies, based on the initial payment credential, the initial payment service to process a second payment for the second purchase;
receive, from the POS unit, the initial payment credential and information of the second purchase to process the second payment;
select, based on the information of the second purchase, a second payment rule from the plurality of payment rules, wherein the second payment rule specifies a spending limit for a purchase category of the second purchase;
retrieve, from a financial management application (FMA) used by the consumer, a cumulative spending amount associated with the purchase category of the second purchase;
determine that a sum of the cumulative spending amount and an amount of the second purchase exceeds the spending limit; and
hold, in response to the determining, the second payment without completing the second purchase.

15. The system of claim 14, further comprising:
a mobile device of the consumer that is configured to display a notification of holding the second payment based on the spending limit,
wherein the initial payment service is further configured to send the notification to the mobile device.

16. A non-transitory computer readable medium storing instructions for processing payments, the instructions, when executed by a computer processor, comprising functionality for:
obtaining, by an initial payment service, a plurality of payment rules, wherein the plurality of payment rules are based on a budget requirement of a consumer;
obtaining, from the consumer by a point-of-sale (POS) unit of a merchant, an initial payment credential to pay for a first purchase, wherein the initial payment credential is used by the POS unit to identify the initial payment service;
receiving, from the POS unit by the initial payment service, the initial payment credential and information of the first purchase to process a first payment for the first purchase;
selecting, by the initial payment service based on the initial payment credential and the information of the first purchase, a first payment rule from the plurality of payment rules, wherein the first payment rule specifies a first budget control condition to qualify the first purchase;
retrieving, by the initial payment service based on the initial payment credential and from a financial management application (FMA), first cumulative spending information of the consumer to qualify the first purchase based on the first budget control condition; and
processing, subsequent to the retrieving from the FMA, the first payment in response to qualifying the first purchase.

17. The non-transitory computer readable medium of claim 16,
wherein the POS unit comprises a physical device installed in a physical store of the merchant, and
wherein the initial payment credential is captured by the POS unit from a BudgetCard of the consumer.

18. The non-transitory computer readable medium of claim 16,
wherein the POS unit comprises a user interface of an online store of the merchant, and
wherein the initial payment credential is input into the POS unit by the consumer via the user interface.

19. The non-transitory computer readable medium of claim 16, the instructions, when executed by the computer processor, further comprising functionality for:
generating, by the FMA, the plurality of payment rules based on the budget requirement;
retrieving, by the FMA and from a financial institution processing the first payment, a financial transaction record representing the first payment;
analyzing, by the FMA, spending of the consumer based at least on the financial transaction record and the first cumulative spending information to generate a result; and
generating, by the FMA, a report based on a comparison of the result and the budget requirement.

20. The non-transitory computer readable medium of claim 16, wherein the first payment rule further specifies a first payment credential of the consumer, and wherein processing the first payment comprises:
identifying, by the initial payment service, a first payment service based on the first payment credential; and
sending, by the initial payment service, the first payment credential to the first payment service to process the first payment.
